(19) United States
(12) Patent Application Publication
(10) Pub. No.: US 2014/0120980 A1
(43) Pub. Date: May 1, 2014

(54) CAMERA-BASED CARE MONITORING DEVICE WITH A TELEPHONY INTERFACE

(71) Applicant: Vagelis Mariatos, Patras (GR)

(72) Inventor: Vagelis Mariatos, Patras (GR)

(21) Appl. No.: 13/664,438

(22) Filed: Oct. 31, 2012

(51) Int. Cl. H04W 88/02; H04W 84/12

(52) U.S. Cl. 455/556.1

(57) ABSTRACT

A device which integrates a smart camera with person detection functionality and a remotely controlled telephone dialer is proposed. The device is used for monitoring elderly and disabled persons while at home and is expandable with internet and television connectivity if such infrastructure is available at the persons residence.

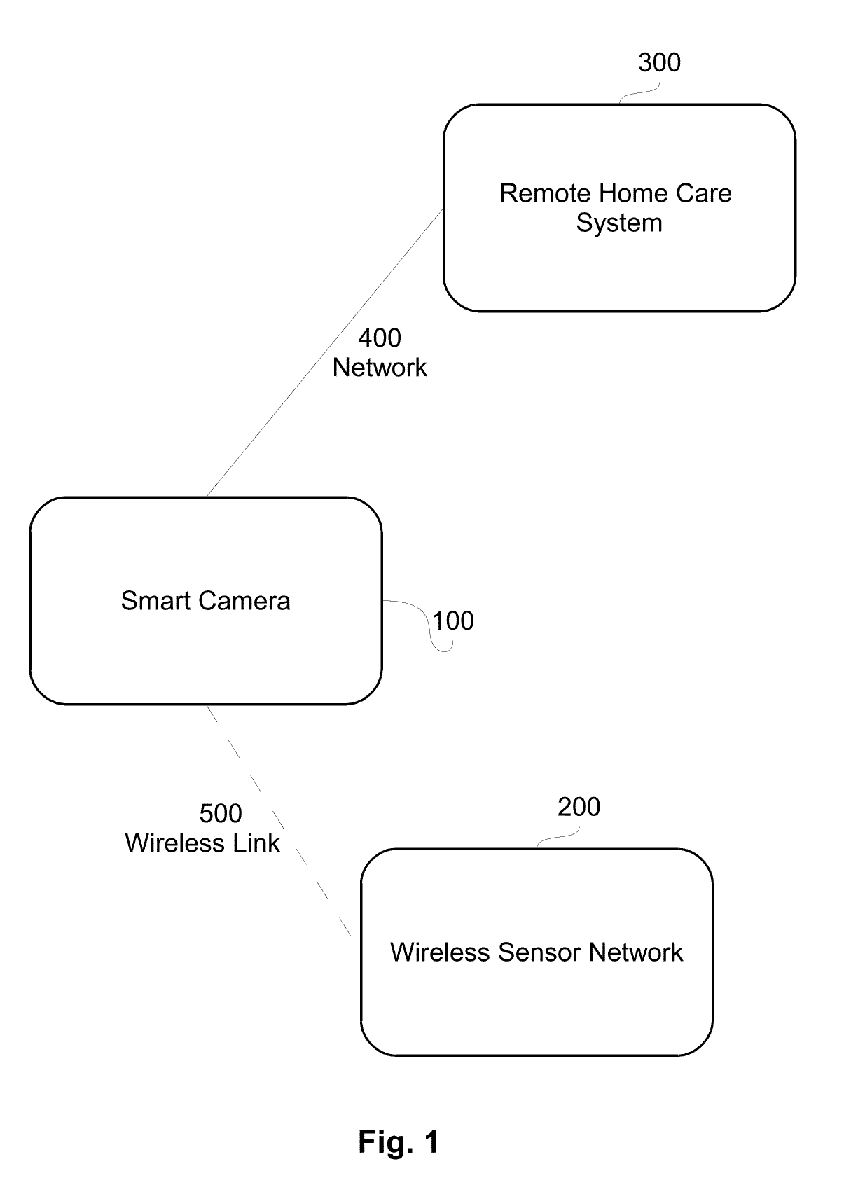

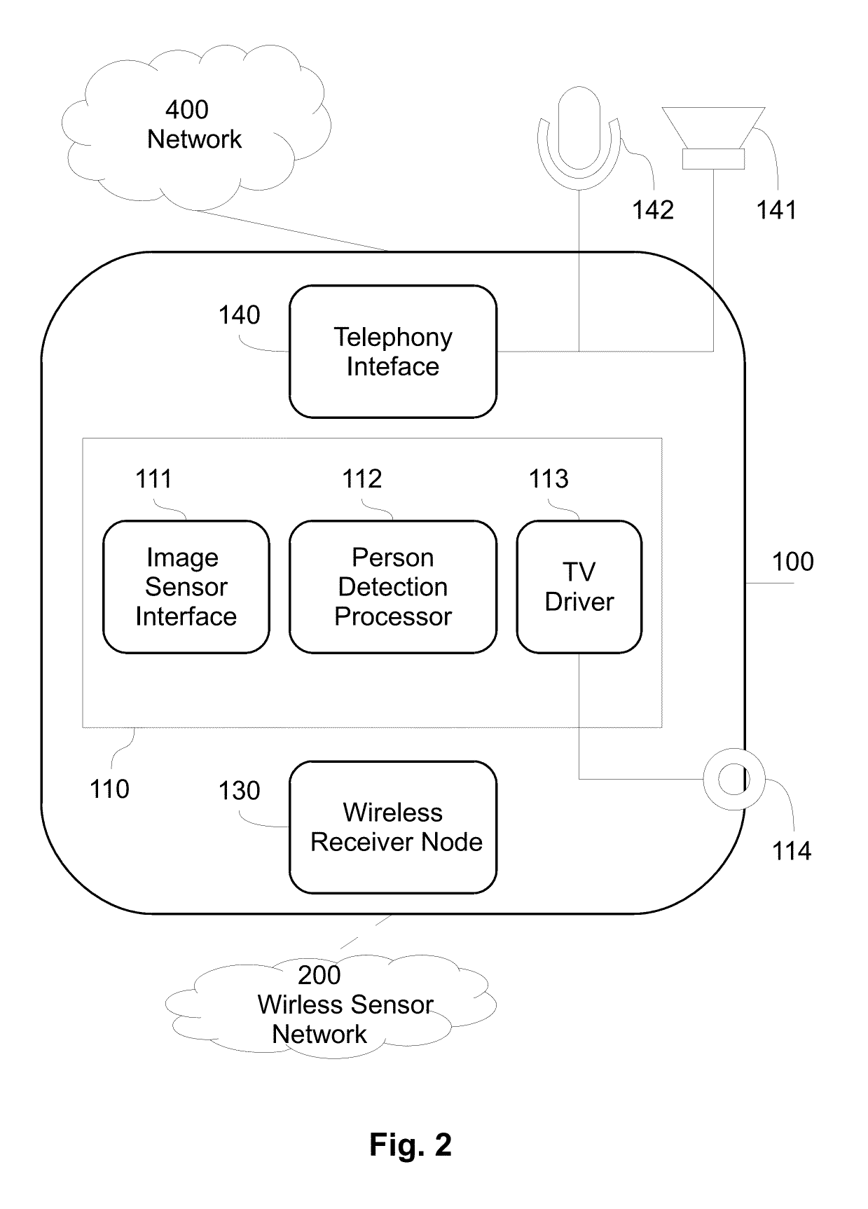

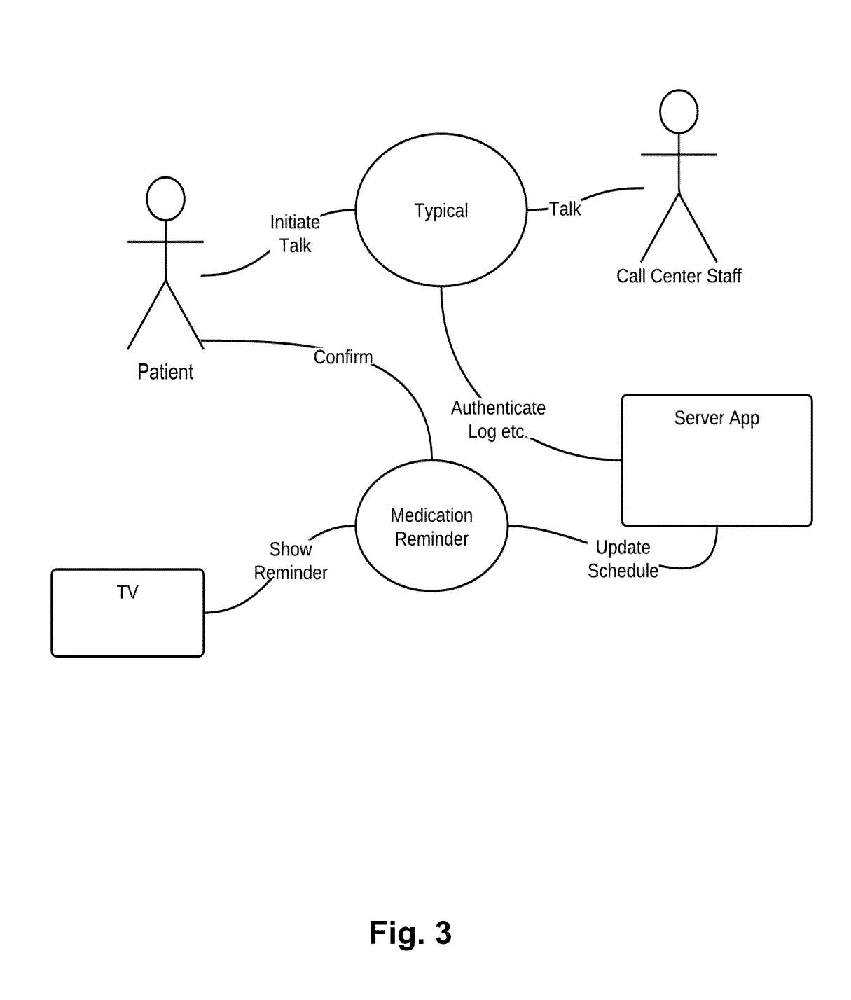

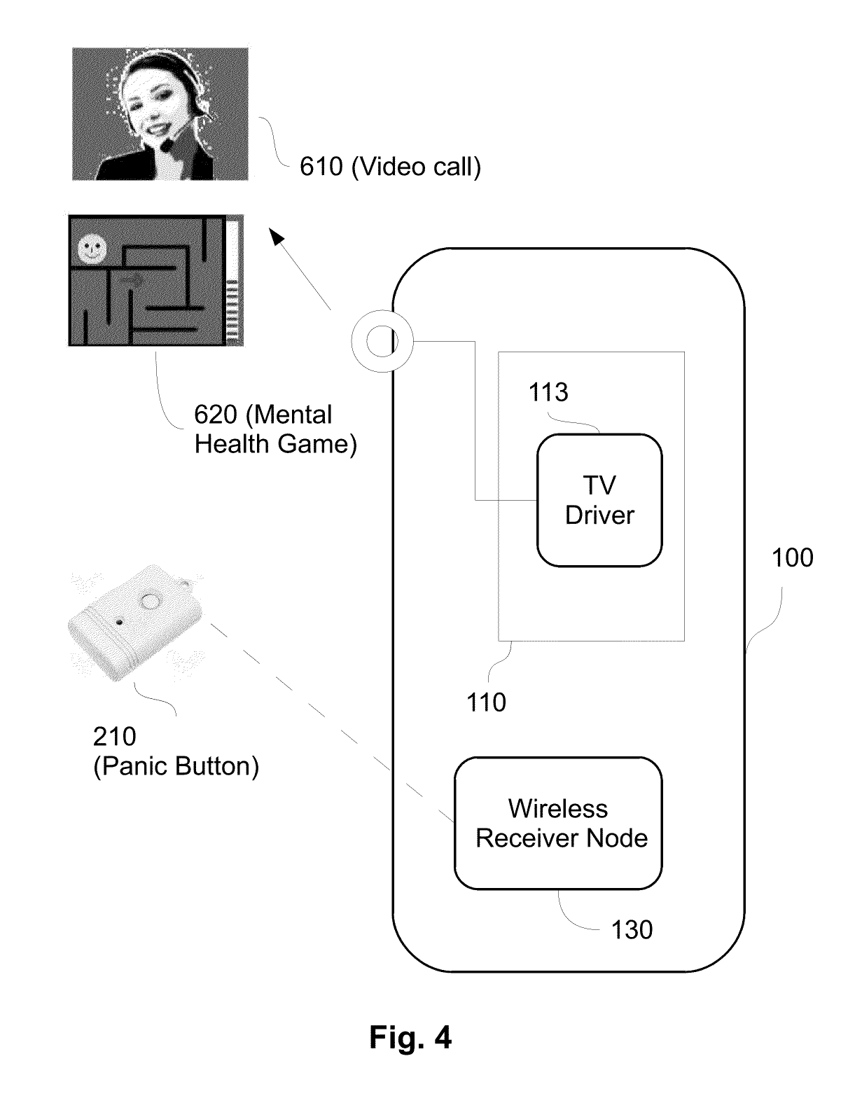

A device which integrates a smart camera with person detection functionality and a remotely controlled telephone dialer is proposed. The device is used for monitoring elderly and disabled persons while at home and is expandable with internet and television connectivity if such infrastructure is available at the persons residence.

### BACKGROUND OF THE INVENTION

Monitoring of persons with disabilities while at home provides the benefits of independence for the subjects and of reduced costs to the health care system as it allows minimizing hospitalization periods. Various devices are available that give the person a button-like interface for remote notification. Also, many sensors—including vision sensors that use cameras—have been proposed for automatic detection of events that should trigger intervention by the service provider. The proposed device is an integrated system that combines the telephone, the smart camera and the receiver in a single low-cost unit which used infrastructure existing in almost all homes.

A person detection smart camera is a device which uses an image sensor to capture frames from a scene and a processor to analyze these frames and recognize presence and posture of humans. In contrast to simple presence detectors used in security installations, a person detection camera does not generate false alarms when animals or other non-human objects appear in its viewpoint.

The usage of smart cameras for detection of persons is not a new concept, especially in the surveillance market. Citing only a few of the related prior work we can refer to U.S. patent application Ser. No. 10/416,868 with describes a smart camera design. An object detection system that links persons via tags is disclosed in U.S. Pat. No. 7,180,050. For U.S. patent application Ser. No. 12/272,122, a model based technique is used in people counting and can also be expanded in other use cases. U.S. Pat. No. 7,557,825 describes a specialized person detection smart camera while U.S. patent application Ser. No. 10/998,150 shows a method for multiple person detection. A collection of techniques for person detection is given in U.S. patent application Ser. No. 12/777,499. Such techniques are also used to create a human detection camera in U.S. Pat. No. 7,409,091.

A panic button/dialer system is a method that gives elderly and disabled people freedom to stay alone in their homes. The panic button is a small easy to use portable button that—once pressed—sends a signal to the dialer. The dialer calls a remote center where specialized staff take care of the event either by calling back or by notifying relatives and care personnel.

In what regards home care dialers and panic buttons, there are already products on the market and the interfaces used are part of a wider standardization effort by the Continua Alliance in the United States and the European AAL (Ambient Assisted Living) initiative. In U.S. patent application Ser. No. 12/945,827 the inventors describe a wireless panic button that is capable of connecting to a variety of networks via specialized receiver units. Various panic button configurations—both wired and wireless—are disclosed with U.S. Pat. No. 6,807,564. Another patent application (U.S. patent application Ser. No. 11/201,185) describes a wired panic button for making emergency calls. A method for routing panic messages from a button through a network of sensors is presented in U.S. patent application Ser. No. 12/237,145. The concept of having a display attached to the receiver unit of a wireless panic button system is disclosed in U.S. patent application Ser. No. 13/218,378.

One of the issues that make adoption of home monitoring difficult by elderly persons is that they are not very familiar with new user interfaces either computer based or tailor made. On the other end, almost everyone is capable of controlling a television set. Furthermore, the home TV is probably the attention center of a person who is home alone so already a few attempts to provide TV-based interfaces for elderly and disabled have been made: U.S. patent application Ser. No. 12/490,917 describes an IPTV based healthcare services provision mechanism that employs a customized set-top-box unit. Also, the European project GUIDE (“Gentle user interfaces for elderly people” which is creating a software framework and design tools that allow developers to integrate accessibility and personalisation features into their applications) puts a dedicated focus on the emerging Web & TV platforms and services (Connected TVs, Set-Top Boxes, etc.).

The currently available or proposed devices already provide valuable services to persons in need. However their scope is limited due to the combination of functions that each system offers. A coarse categorization reveals two trends:

(a) Simple panic button/receiver pairs which aim at simply forwarding the event of a pressed button to a service provider. This is very widely used—mainly because of a very low cost that allows service providers to give it for free as part of the entire offering. The problem with these devices is that they have no automatic event detection capability. Another problem is that there is not a clear local feedback apart from the call back—minimizing the subjects confidence to the system. Finally, these systems cannot be used for medication reminders, mental-health games or any other interactive activity.

(b) High-end home care centers that employ personal computer technology. These devices are actually PCs with special enclosure and touch screen interfaces and can be used to connect event detection sensors, panic buttons, pill dispensers and many other peripheral units. Although they provide a complete set of capabilities, they also have a number of issues that have limited their actual deployment in the market:
Due to the used complex technology they are quite expensive, making it non-practical to be given for free with a service provision contract. Direct purchasing by the customers would also incur high hosts on the end user, and could also raise compatibility and interoperability issues as different users on the same care-provider would use different devices.
They need an existing internet connection infrastructure. In most parts of the world this is not a big issue but limits applicability to long-term patients who can install a internet connection as they will be using it or to already connected homes. Also, many parts of the world do not offer internet connectivity, especially is remote villages or islands.
Even though the user interfaces of these devices are specifically designed with ease-of-use in mind, there is always the need of some training. For persons with mental disorders some times training is not an option at all.
They rely on a variety of external sensors for event detection so even if a central device is installed the performance of the system will still rely on the performance of the peripheral devices.

### SUMMARY OF THE INVENTION

The solution disclosed with this invention fills a gap in the current offerings by providing an affordable system which still has most of the functions available with high-end systems. The key characteristics of the invention are:
It provides a wide angle of detection capabilities with only two sensors: Camera and Button. The disclosed invention can rely on the the camera for detection of events like unexpected house exit, fall on the floor, panic, intruders etc. A wireless button is used for triggering connection when no event is detected by the camera but the person needs assistance. It is also a medium of communication with the system.
It uses existing infrastructure: phone and TV. Our solution uses the existing PSTN—standard telephone-installation as a communication mechanism. However it is not limited to a simple phone call but can also send and receive information including even photos captured by the smart camera, so that the care-provider personnel can assess the situation.
It can be expanded as it can take advantage of internet infrastructure if available. Furthermore, as the connection to the panic button is based on the IEEE 802.15.4 standard, other types of specialized sensors can be attached and used by the system.

### BRIEF DESCRIPTION OF DRAWINGS

A quick list of the drawings follows:

Drawing 1: An overview of the care system build around the smart camera monitoring device.

Drawing 2: The internal architecture of the smart camera monitoring device.

Drawing 3: An example use case diagram showing how the patient uses the system.

Drawing 4: A simplified example of the smart camera monitoring device used as a TV set top box.

### DETAILED DESCRIPTION OF THE INVENTION

The following description of the invention lays out the details of constructing and using the disclosed smart camera monitoring device. The said integrates a smart camera with person detection functionality and a remotely controlled telephone dialer. The device is used for monitoring elderly and disabled persons while at home and is expandable with internet and television connectivity if such infrastructure is available at the persons residence.

As outlined in Drawing 1, the smart camera monitoring device (100) is the centre of an entire home care system. This device is installed in the residence of a person who needs constant monitoring—preferably in a location which has a good viewpoint a the living room, usually in from of the television set. Installation needs access via cable to the television set and to the telephone socket. The front cover of the device must not be covered so that the camera sees the room and the devices microphone and speaker are free. The smart camera monitoring device (100) uses an in-house and an external network to interface to the world. The in-house network is a wireless sensor system (200). The smart camera connects to it via a standard 802.15.4 wireless link (500). In a typical installation the nodes of the sensor network (200) will be the smart camera and a panic button. Further types of nodes can include:

Detectors of smoke, water or other potential dangers
Extra buttons—e.g. by the bed during night sleep or near the entrance
Other smart cameras to monitor more rooms of the house
Automatic pill dispensers
Wireless microphone and speaker

The smart camera monitoring device (100) communicates with the network nodes and decides if a call should be made to a care-provider. This is accomplished by using the telephone network (400) or the internet if available. The call reaches the call center of the care provider (300). In this center (300) a server with database access can be used to automatically retrieve the patients data and event log and trained personnel handle each event. Typical functions provided by the central sever (300) are:
Event handling via person-to-person phone talk
Medication Reminders
Activity (physical or mental) monitoring and recording
Forwarding of events, calls, reminders and records to authorized relatives

Getting into the internals of the presented smart camera monitoring device as shown in drawing 2, the camera (100) is built around an integrated circuit or field programmable gate array FPGA (110). The FPGA (110) implements system management circuitry and some major parts of the camera architecture. The picture frames which capture the cameras viewpoint come into the system via a CMOS image sensor. The FPGA implements interface to this sensor (111) via a hardware block which performs pixel synchronization, automatic intensity and color balance, color channel demosaicing, image scaling and integral image calculation. This data is fed through an onchip bus into the Person Detection Processor (112) unit in the FPGA. This block uses a central processing unit—CPU—and dedicated hardware accelerators to implement presence and posture detection algorithms.

A variety of algorithm can be implemented depending on the specific event that the smart camera has to recognize. Typical algorithms implemented recognize events like:
Person entry or exit through a specified door or direction
Level of activity e.g: asleep, non moving awake, walking around, physical exercise or irregular panic movement
Specific events like fall on the floor, stay in bed too long, entrance of a second person

The smart camera stores these events and a photographic snapshot and decides whether a call has to be made to the care-provider. The devices FPGA (110) also includes circuitry (113) that can drive image output to a television set via—in one embodiment—an RCA socket (114) carrying composite TV signal. In other embodiments of the invention the SCART or the HDMI connectors may be used, however we need to take into account that the device has to be as widely usable as possible so any TV interface that is new could limit out users with older TV sets.

To receive events from the in-house wireless sensors (200), the smart camera monitoring device integrates a complete 802.15.4 node which acts as a receiver (130). The said receiver also provides wireless sensor synchronisation and maintenance allowing the remote nodes to operate in a very low power state—saving battery lifetime. In one embodiment, the wireless receiver (130) unit is implemented on a separate printed circuit board with a printed antenna and a system-on-chip 802.15.4 receiver/transmitter with integrated microcontroller. This integrated microcontroller is programmable via the FPGA and can also run parts of the entire smart camera software.

The devices connection to the telephone-network (400) is achieved by an on-board telephony interface circuit (140). This circuit implements automatic dialing and call answering as well as a low speed data communication protocol using DTMF-level tones. The smart camera monitoring device also integrates a complete speakerphone. This is supported by the telephone interface circuitry (140). It gets the voice from the person in the house through a microphone (142) and brings sound from the remote care-provider call center on a speaker (141). In this way, there is no need to attach a separate telephone device to the socket which might be tough for a person in urgent need to reach and operate.

To better illustrate usage of the smart camera monitoring device, drawing 3 gives a use case diagram showing two typical scenario. The most typical scenario is a case where the patient initiates talk to care-provider personnel. This can be triggered either automatically by the camera when it detects an event or by the patient pressing the panic button. Another case is when the application at the care-provider server notifies the user for some treatment, e.g. a pill that has to be taken. This reminder initiates a call which is automatically answered by the telephony circuit in the camera and displays a message on the television set. The patient confirms that the message was read and the medication is taken by pressing the button or by making a special gesture in front of the camera. All activities are recorded in the server-side database.

A simplified example of the smart camera monitoring (100) device used as a TV set top box is shown in drawing 4. This example does not use the image sensor for monitoring but for detecting gestures and patient face to run specific applications through the television set. The patient can also use the wireless panic button (210) to add interaction.

The TV driver (113) in the cameras FPGA (110) runs TV image construction—this image sent in real time via the RCA cables to a TV set where one of two applications display:
Video Conferencing (610) between the patient and care-provider staff. Video conferencing can also be supported with relatives or with other patients that have the same or a compatible smart camera monitoring device. If there is an active internet connection the conferencing resolution and clarity is of high quality. On a simple phone line the conferencing has to operate at lower resolution and slower frame rates since that available bandwidth is very limited.
Mental health games (620) like maze which help the person maintain a level of brain activity—as staying alone sometimes accelerates the prognosis of mental illness.

What is claimed is:

1. a device comprising of an image sensor unit, an image processing unit with the capability to detect persons in space, a telephone-network interface and a wireless receiver unit, being capable of forwarding detected events through the said telephone network

2. a device as in claim 1, where the image processing unit is implemented with one or more field programmable gate array integrated circuits

3. a device as in claim 1, where the wireless receiver unit uses the IEEE 802.15.4 protocol

4. a device as in claim 1 with the addition of a local area network port compliant to the IEEE 802.3 standard

5. a device as in claim 1 with the addition of a wireless area network port compliant to the IEEE 802.11 standard

6. a device as in claim 1 with the addition of a port that drives output to a television set in order to provide visible information

7. a device as in claim 1 where the telephone-network interface includes a hands-free telephone unit providing the capability for open talk between the local user and a remote agent

8. a device that drives output to a television set in order to provide visible information further comprising of a telephone-network interface and a wireless receiver unit, being capable of forwarding detected events through the said telephone network
